(19) United States
(12) Patent Application Publication
(10) Pub. No.: US 2003/0171859 A1
(43) Pub. Date: Sep. 11, 2003

(54) Car performance addition service providing system, acquiring system, method, and storage medium

(76) Inventor: Atsushi Murakoshi, Kawasaki-Shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/400,562

(22) Filed: Mar. 28, 2003

Related U.S. Application Data
(63) Continuation of application No. PCT/JP00/06728, filed on Sep. 28, 2000.

(51) Int. Cl. G01M 17/00; G06F 7/00

(52) U.S. Cl. 701/29; 701/33

(57) ABSTRACT

According to the present invention, there is disclosed a car performance addition service providing system in which a predetermined setting division provides an addition service relating to a performance to a car using an electronic control via communication, the system comprising a first transmission unit which transmits setting information relating to the performance to the car, an acceptance unit which accepts a request for desired performance setting from the car in accordance with the setting information transmitted by the first transmission unit, and a second transmission unit which transmits setting data corresponding to the request accepted by the acceptance unit to the car.

### CROSS-REFERENCE TO RELATED APPLICATIONS

This is a Continuation Application of PCT Application No. PCT/JP00/06728, filed Sep. 28, 2000, which was not published under PCT Article 21(2) in English.

### BACKGROUND OF THE INVENTION

1. Field of the Invention

The present invention relates to a car performance addition service providing system, acquiring system, method, and storage medium.

2. Description of the Related Art

A related-art car has been mechanically controlled excluding an ignition system and electric equipment system. Therefore, the handling of a driving environment largely depends on a driver's capability. However, a driving sense and considerations toward a fellow passenger largely differ with a driver's nature.

For example, during the driving with an infant, it is necessary to pay a closest attention in driving the car without any rapid acceleration/braking, but the attention is not especially paid depending on the driver. Moreover, an aged driver sometimes feels that a power performance of the car is over-specified, different from drivers who have speed senses of a young generation. In this case, it is considered that it is requested for the driver to enlarge a torque with a maximum speed to 80 km/h rather than to set the maximum speed to 180 km/h for ease of low-speed driving. In this manner, the required driving performance/power performance of the car largely differ with the driver's individuality/nature.

The cars which have generally spread are manufactured based on the driving performance/power performance adapted to people who have average driving nature. Therefore, a degree of freedom of driving spreads. On the other hand, the driving environment is sometimes inappropriate for people such as aged and handicapped people.

By these circumstances, with the spread of the car which uses an electronic control in, future, there is a demand for the setting of performances suitable for various driving environments. However, even if the functions are added for various driving environments, there is fear that the driver is confused by too many functions. Moreover, it is assumed that only the necessary function is added. Even in this case, when the function is not required, a necessity of changing the setting arises.

### BRIEF SUMMARY OF THE INVENTION

An object of the present invention is to provide a car performance addition service providing system, acquiring system, method, and storage medium in which the setting of a driving environment can appropriately be provided or acquired in accordance with a user's request in a car using an electronic control.

According to the present invention, there is provided a car performance addition service providing system in which a predetermined setting division provides an addition service relating to a performance to a car using an electronic control via communication, the system comprising: first transmission means which transmits setting information relating to the performance to the car; acceptance means which accepts a request for desired performance setting from the car in accordance with the setting information transmitted by the first transmission means; and second transmission means which transmits setting data corresponding to the request accepted by the acceptance means to the car.

According to the present invention, there is provided a car performance addition service acquiring system in which a car using an electronic control receives an addition service relating to a performance from a predetermined setting division via communication, the system comprising: first reception means which receives setting information relating to the performance from the setting division; request means which requests desired performance setting of the setting division in accordance with the setting information received by the first reception means; second reception means which receives setting data corresponding to the request of the request means from the setting division; and change means which changes the setting of a corresponding portion by the setting data received by the second reception means.

According to the present invention, there is provided a car performance addition service providing method of providing an addition service relating to a performance to a car using an electronic control from a predetermined setting division via communication, the method comprising: a step of receiving communication connection to the setting division from the car; a step of transmitting setting information relating to the performance to the car; a step of receiving a request for desired performance setting to the setting division in accordance with the setting information from the car; and a step of transmitting corresponding setting data to the car in response to the request from the car.

The present invention allows a computer to function as: first transmission means which transmits setting information relating to a performance to a car using an electronic control; acceptance means which accepts a request for desired performance setting in accordance with the setting information transmitted by the first transmission means from the car; and second transmission means which transmits setting data corresponding to the request accepted by the acceptance means to the car.

The present invention allows a computer to function as: first reception means which receives setting information relating to the performance of a car using an electronic control from a predetermined setting division; request means which requests desired performance setting of the setting division in accordance with the setting information received by the first reception means; second reception means which receives setting data corresponding to the request of the request means from the setting division; and change means which changes the setting of a corresponding portion of the car by the setting data received by the second reception means.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing a configuration of a car performance addition service providing system according to an embodiment of the present invention;

FIG. 2 is a diagram showing a communication procedure among a user (car), car sales company, setting company, and repair center; and

FIGS. 3A to 3J are diagrams showing screens of a display device of an operation terminal disposed in the car.

### DETAILED DESCRIPTION OF THE INVENTION

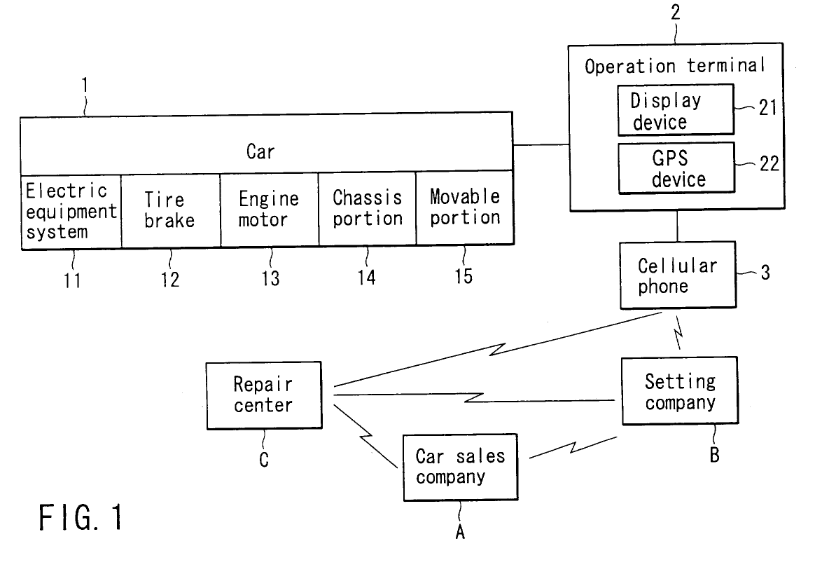

FIG. 1 is a diagram showing a configuration of a car performance addition service providing system according to an embodiment of the present invention.

In FIG. 1, in a car 1 which is an object of service providing, a power performance, braking performance, operating performance, riding comfort, and the like are electronically controlled. The car 1 includes an electric equipment system 11, tire brake 12, engine motor 13, chassis portion 14, movable portion 15, and the like, and these components are objects of an electronic control.

An operation terminal 2 is disposed in the vicinity of a driver's seat in the car 1, and the operation terminal 2 includes a computer and display device 21 which also serves as in input unit. A connector (not shown) of the operation terminal 2 is connected to a cellular phone 3. Moreover, a GPS device 22 is disposed in the operation terminal 2.

Communication with a car sales company A, setting company B, and repair center C is possible by the cellular phone 3 from the inside of the car 1 via a communication circuit. The car sales company A is a company from which a user purchased the car 1, the setting company B is a specialized company which provides a car performance addition service to the user, and the repair center C is a company which provides a repair service to the user's car 1. These car sales company A, setting company B, and repair center C have a mutually affiliated relation. Furthermore, the setting company B and repair center C also affiliate with financial companies such as a credit card company, a member of which the user of the car 1 is.

The setting company B uses communication functions of the cellular phone and GPS to provide a necessary driving environment to the user (driver) of the car 1. The car performance addition service by the setting company B does not include component replacement of a car main body, and is characterized in that a programmed operation system, so-called software is provided if desired by the user.

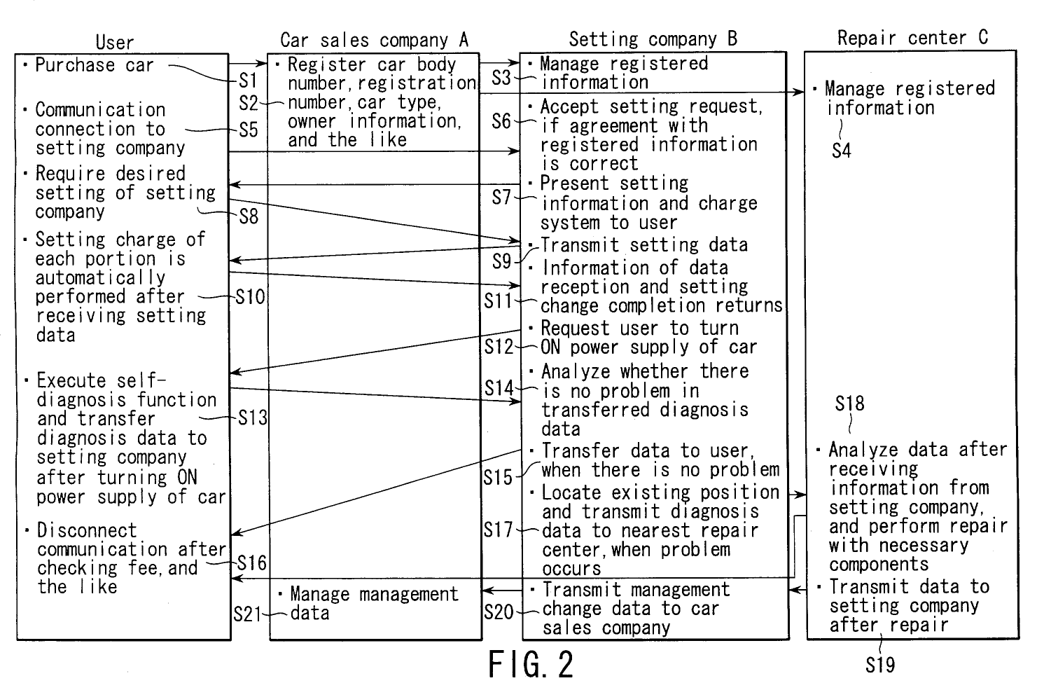

FIG. 2 is a diagram showing a communication procedure among the user (car 1), car sales company A, setting company B, and repair center C. The communication shown in FIG. 2 is performed among the operation terminal 2 of the car 1 and the respective computers of the car sales company A, setting company B, and repair center C.

First, when the user purchases the car 1 in step S1, the operation terminal 2 transmits user information such as “car body number”, “registration number”, “car type”, and “owner (user) information” of the car 1 to the car sales company A via the cellular phone 3. In step S2, the car sales company A registers these information in its own computer. It is to be noted that the user information may also be registered by the car sales company A at a purchase time, not after the purchase of the car 1.

Subsequently, the car sales company A transmits the user information to the setting company B and repair center C, and the setting company B and repair center C register and manage received information in their own computers in steps S3, S4.

Next, when the setting of the driving environment in the car 1 needs to be changed, the user brings a power supply of the car 1 into a standby state, performs communication connection (dial-up connection) to the setting company B from the operation terminal 2 via the cellular phone 3 in step S5, and requests the setting. In this case, the user transmits the user information such as the “car body number”, “registration number”, “car type”, and “owner information” of the car 1 from the operation terminal 2.

In step S6, the setting company B extracts authentication data from the information received from the user, and judges whether or not the information agrees with the registered information managed by the company. Here, with the agreement, the setting company B accepts the request for the setting, and communication-connects its own terminal server to the user. With non-agreement, the communication connection to the user ends.

With the agreement in the step S6, in step S7, the setting company B presents setting information and charge system to the user's car 1 via communication. Then, in step S8, the user refers to the setting information and charge system presented from the setting company B in the display device 21 of the operation terminal 2, and requests desired setting to the setting company B from the operation terminal 2 via the cellular phone 3. Moreover, when the user does not request the setting, the user notifies the setting company B of this. It is to be noted that when a contract to pay a constant amount of fee by a unit of year or month is concluded between the user and setting company B, the charge system is not presented.

In step S9, the setting company B transmits the setting data to the user in response to the setting request received from the user. Then in step S10, in the user's car 1, after the setting data is received from the setting company B, the setting of a corresponding portion is automatically changed. After this setting change ends, in step S11, the user transmits information of setting change completion to the setting company B.

Next in step S12, the setting company B requests the user to turn ON the power supply of the car 1. Subsequently in step S13, after the user turns ON the power supply of the car 1, a self-diagnosis function of the car 1 is executed, and diagnosis data is transmitted to the setting company B. It is to be noted that this self-diagnosis function is executed, every time the user turns ON the power supply of the car 1, that is, every time the car 1 is started. Therefore, the user can confirm whether or not a disadvantage is generated in the car 1 every start, and safety is enhanced.

In step S14, the setting company B analyzes whether there is no problem in the transferred diagnosis data. Here, when there is not any problem, in step S15, the setting company B notifies the user of fees, and the like relating to the setting. Subsequently in step S16, the user checks the fees, and the like and thereafter disconnects the communication.

Moreover, when there is a problem in the diagnosis data in the step S14, in step S17, the setting company B locates the existing position of the car 1 from the data sent from the GPS device 22 of the car 1, searches for the nearest repair center C, and transmits the diagnosis data.

In step S18, the nearest repair center C receives the diagnosis data from the setting company B, and analyzes the data (or receives an analysis result of the diagnosis data in the setting company B). Thereafter, a serviceman brings necessary components, and the like, visits the existing position of the car 1, and performs repair. Thereafter, the repair center C notifies the user of the fees, and the like relating to the repair. Subsequently in step S16, the user confirms the fees, and the like, and thereafter disconnects the communication. In this manner, the setting by the setting company B and the repair by the repair center C are performed with the same contents.

In step S19, the repair center C transmits data concerning the repair to the setting company B after the repair. Subsequently, in step S20, the setting company B changes management data concerning the car 1 based on data received from the repair center C, and transmits the data to the car sales company A. Subsequently in step S21, the car sales company A manages the received management data of the car 1 in its own computer. Similarly, also in the setting company B and repair center C, the changed management data of the car 1 is managed by their own computers.

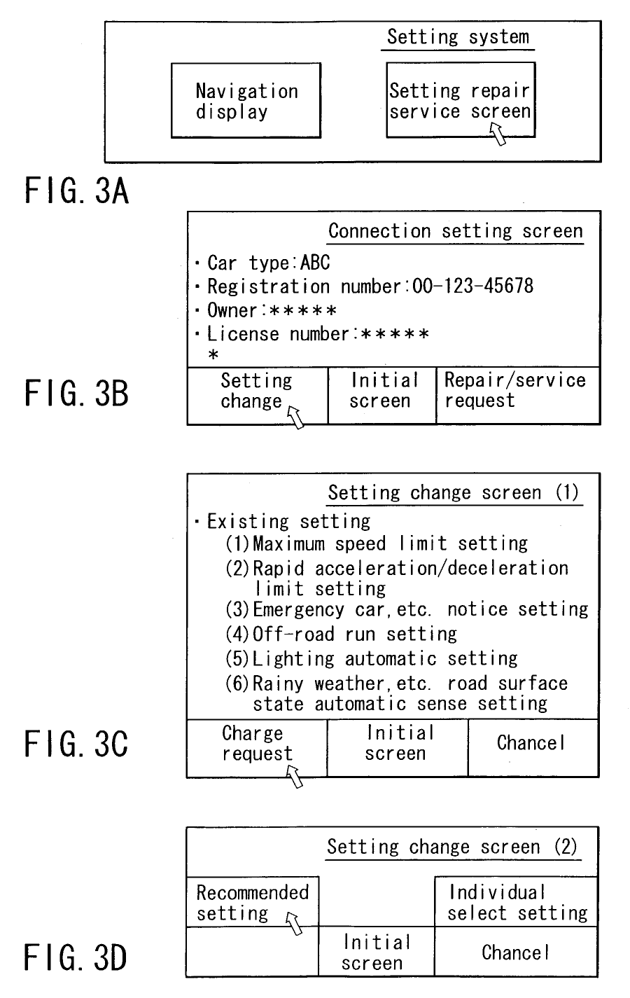

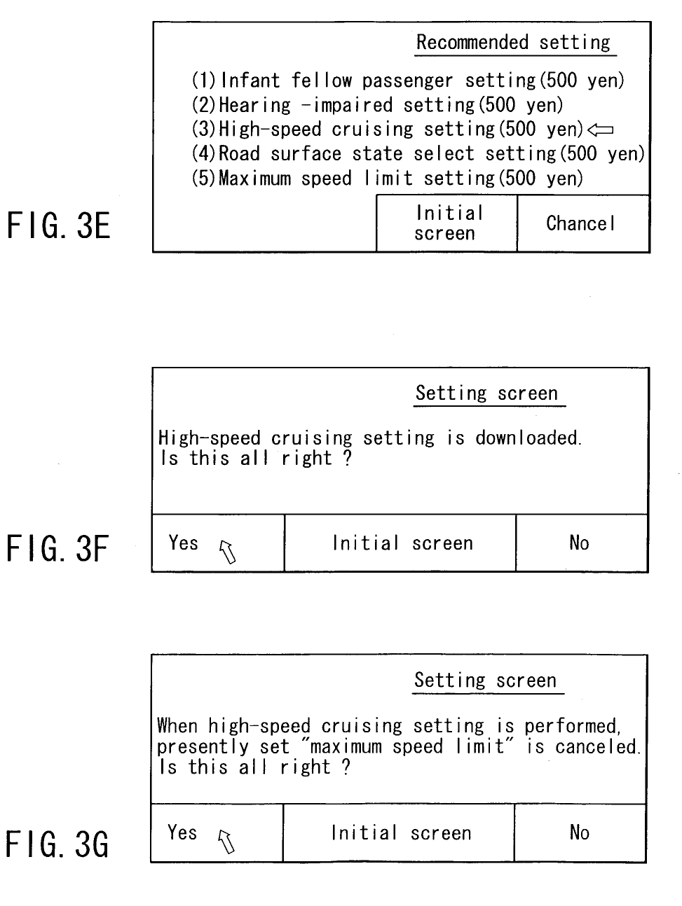

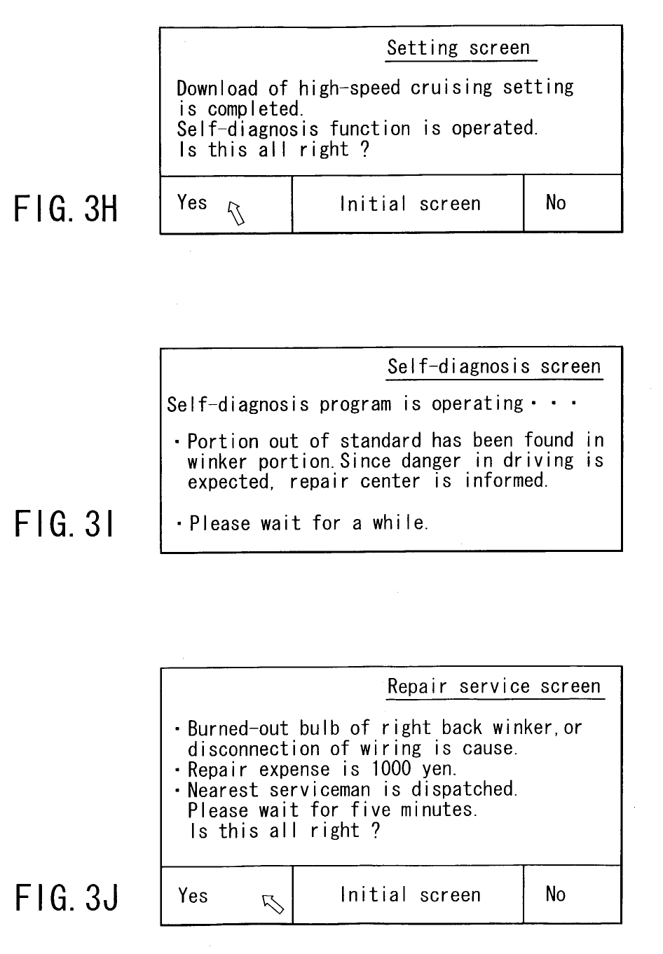

FIGS. 3A to 3J are diagrams showing screens of the display device 21 of the operation terminal 2 disposed in the car 1. This screen serves both as a monitor and touch panel, and the user touches the screen to perform various inputs while seeing screen display. An operation procedure by the above-described car performance addition service providing system will be described hereinafter with reference to FIGS. 3A to 3J.

(1) First, the user purchases a desired car from the car sales company A. In the car sales company A, the user information such as the “car body number”, “registration number”, “car type”, and “owner information” are inputted. Additionally, these information are inputted and managed in the setting company B and repair center C.

(2) When the user brings the power supply of the car 1 in a standby state, an initial screen shown in FIG. 3A is displayed in the display device 21 of the operation terminal 2. When the user touches a panel of a “setting repair service screen” shown by an arrow in FIG. 3A, a connection setting screen shown in FIG. 3B is displayed.

When the user inputs the “car body number”, “registration number”, “car type”, “owner information”, and the like of the car 1 via the operation terminal 2, these are displayed in the screen shown in FIG. 3B. It is to be noted that the “owner information” includes items known only to the user of the car 1, such as a user's license number of the car 1.

Subsequently, when the user touches “setting change” shown by an arrow in FIG. 3B, the setting company B is accessed through the cellular phone 3. At this time, a standby signal (stop signal) of the car 1 is transmitted to the setting company B together with these information. The standby signal is transmitted, only when the power supply of the car 1 is in the standby state.

It is to be noted that when the user touches the panel of the “initial screen” of the screen of FIG. 3B, the screen returns to the initial screen shown in FIG. 3A. When the user touches the panel of the “repair/service request”, the repair center C is requested for repair.

In the setting company B, when even one item of the received information does not agree with that of the information being managed, the access from the car 1 is not accepted. Moreover, when the standby signal is not received, the access is not accepted. Thereby, an operation by others' mischief is prevented, the operation during the driving is prohibited, and accidents, and the like are prevented from occurring.

On accepting the access, the setting company B presents the setting information and charge system to the user.

(3) A setting change screen shown in FIG. 3C is displayed in the display device 21 of the user's operation terminal 2. The existing setting state in the car 1 is displayed on the screen. For example, in FIG. 3C, “maximum speed limit setting” to limit a maximum speed, “rapid acceleration/deceleration limit setting” to limit rapid acceleration and deceleration, and the like are set. It is to be noted that since the speed is controlled not to exceed, for example, 80 km/h in the “maximum speed limit setting”, excess speed is prevented. Moreover, in the “rapid acceleration/deceleration limit setting”, control is executed for slow acceleration/deceleration, and fellow passenger's riding comfort is improved.

Moreover, when the user touches a panel of “change request” shown in an arrow in FIG. 3C, the setting company B is requested to change the setting through the cellular phone 3. It is to be noted that when the user touches the panel of “cancel” of the screen of FIG. 3C, the screen returns to the initial screen of FIG. 3A.

(4) A setting change screen (2) shown in FIG. 3D is displayed in the display device 21 of the user's operation terminal 2. On this screen, selection panels of “recommended setting” and “individual select setting” are displayed. These indicate the setting information presented from the setting company B, the “recommended setting” is a mode for selecting whole coordinate recommended by the setting company B, and the “individual select setting” is a mode for arbitrarily selecting the setting of each portion.

When the user touches the panel of the “recommended setting” shown by an arrow in FIG. 3D, this is notified to the setting company B through the cellular phone 3.

(5) A recommended setting screen shown in FIG. 3E is displayed in the display device 21 of the user's operation terminal 2. On the screen, several setting contents recommended by the setting company B and expenses are displayed.

For example, in “infant fellow passenger setting” in FIG. 3E, suspension is adjusted so that little vibration is given to a fellow passenger during running. Moreover, in “hearing-impaired setting”, for a hearing-impaired driver, with approach of another car during the running, a steering wheel is vibrated and the driver is informed. Moreover, “high-speed cruising setting”, the car runs on an expressway at a constant speed (100 km/h).

Subsequently, when the user touches the “high-speed cruising setting” shown by an arrow in FIG. 3E, this is notified to the setting company B through the cellular phone 3.

Subsequently, a screen which induces download of the high-speed cruising setting as shown in FIG. 3F is displayed in the display device 21 of the operation terminal 2. Here, when the user touches the panel of “yes” shown by an arrow in FIG. 3F, a screen to confirm the setting change as shown in FIG. 3G is displayed.

Subsequently, when the user touches the panel of “yes” shown by an arrow in FIG. 3G, the high-speed cruising setting is requested to the setting company B through the cellular phone 3. Then, data for the high-speed cruising setting is transmitted to the user's operation terminal 2 from the setting company B.

(6) When the download of the high-speed cruising setting ends in the user's car 1, a screen shown in FIG. 3H is displayed in the display device 21. On the screen, it is displayed that the download is completed and that the self-diagnosis function is operated.

Subsequently, when the user touches the panel of “yes” shown by an arrow in FIG. 3H, a message (not shown) for urging the user to turn ON the power supply of the car 1 is displayed. Subsequently, when the user turns ON the power supply of the car 1, the self-diagnosis function operates to diagnose the state of each portion of the car 1, and a screen shown in FIG. 3I is displayed in the display device 21. In this screen, it is displayed that there is an abnormality in the winker portion.

Additionally, the diagnosis data of each portion is automatically transferred to the setting company B from the operation terminal 2, and it is analyzed in the setting company B that the winker portion has the abnormality. In this case, the setting company B instructs the car 1 to execute the self-diagnosis function again.

Moreover, when it is analyzed that the same portion has an abnormality again, or when there is a mechanical breakdown, the setting company B transfers the information obtained by the self-diagnosis function to the nearest repair center C. The repair center C transmits repair content, repair expense, and the like to the user's operation terminal 2.

(7) A repair service screen shown in FIG. 3J is displayed in the display device 21 of the user's operation terminal 2. On the screen, the repair content, repair expense, time until the serviceman reaches the car 1, and the like are displayed. Moreover, when the user touches the panel of “yes” shown by an arrow in FIG. 3J, the setting company B requests the nearest repair center C to dispatch the serviceman through the cellular phone 3. In this case, the information obtained by the self-diagnosis function is transferred to the repair center C, and necessary components, and the like are judged. Since the existing position of the car 1 by the GPS device 22 is notified from the operation terminal 2, the serviceman can quickly go to the car 1 to repair the car.

It is to be noted that when the user touches the panel of “yes” in the screens of FIGS. 3F to 3J, the screens return to the previous screens.

After completing the above-described setting and the repair by the serviceman, the fees are charged from the setting company B and repair center C via the financial companies such as the card company, the member of which the user is.

Operations of the car sales company, setting company, and repair center will be described hereinafter with respect to a user's action in the present car performance addition service providing system.

(1) Car Purchase

User: purchase of the car;

Car sales company: sales of the car, acceptance of user information;

Setting company: acceptance of the user information; and

Repair center: registration of the user information.

(2) Setting Request (Connection)

User: communication connection for setting request; and

Setting company: confirmation of user registration information.

(3) Setting Operation

User: request of arbitrary setting; and

Setting company: transmission of setting program.

(4) Safety Confirmation Operation

User: operation of the self-diagnosis function following the instruction;

Setting company: acquisition/judgment of self-diagnosis information, transmission of information to the repair center with the confirmation of the abnormality, registration of information in the car sales company and repair center; and

Repair center: acceptance of the information from the setting company, confirmation of the user position, dispatch of the serviceman.

(5) Repair Operation

User: waiting following the instruction; and

Repair center: replacement of the necessary components, operation confirmation, registration of the repair content in the registered information.

(6) Completion Procedure

User: start of the driving after the disconnection of the communication; and

Setting company: notification of fee breakdown and service end.

Next, an application example of the present car performance addition service providing system will be described.

(1) In the above embodiment, the providing of the service after the purchase of the car by the user has been described, but the present service can be utilized not only after the purchase but also before the purchase. In this case, when the user considers the purchase of the car in the car sales company, desired setting data is inputted into a demonstration-model car to test the car. Moreover, the car sales company can present an estimate of the car including the expense relating to the setting required by the user.

(2) In the present service, it is also possible to perform the setting of interior environments of the car, such as adjustment of an indoor light and adjustment of the height of the sheet, and to set a sleep preventive function by sound generation, and the like.

(3) In the above-described embodiment, GPS is used in detecting the existing position of the car, but it is expected to detect the position with the cellular phone or PHS in future.

(4) By link with not only the sales division, setting division, and repair division of the car but also emergency treatment facilities, and the like, an emergency time can quickly be handled.

(5) By a method of preventing the system from operating as long as the user information (personal information) does not agree with car body information, even a theft accident measure of the car can be taken.

(6) The present system is linked with various insurance systems, thereby rapid treatment at an accident occurrence time and compensation for an injured person are securely performed, and an injured person's loss can be reduced in an accident by a person who has not taken out an insurance policy.

(7) When the self-diagnosis function in the present system is reinforced, the car can always be kept in a maintained state, and relaxation of a safety check system and reduction of traffic accidents can be achieved.

(8) The present system can also be applied not only to a personal car but also to cars for various businesses, rented car, and automatic bicycle.

(9) In the present system, when the contract to pay the constant amount of fee by the unit of year or month is concluded between the user and setting company, the charge system relating to the setting change is not presented to the user, and of course individual change expenses are not notified. However, the dispatch expense of the serviceman, required component cost, repair technical expense, and the like are notified to the user, unless a special contract is concluded.

In the car performance addition service providing system according to the present invention, the communication functions of the cellular phone and GPS can be used to take the functions necessary for the driving environment required by the driver into the car main body. That is, basic characteristics of the present service do not lie in the component replacement of the car main body, and lie in that the programmed operation system, so-called software is provided if necessary. Concretely, the data of ROM relating to CPU of each portion, which performs the electronic control, is rewritten.

For the present service, the car using the electronic control in controlling each portion is the object, for example, an output characteristic of an engine (motor) is changed to a characteristic suitable for a driver's request, and initial adjustment or expansion/contraction ratio of the electronic control suspension, and the like are changed, so that the driving environment suitable for the driver/fellow passenger is provided. Moreover, for example, for the hearing-impaired driver, the approach of a crossover or emergency vehicle is sensed by a sensor, and vibration is transmitted to the steering wheel, and it is possible to provide the driving environment in response to broad needs in this manner.

As described above, in the present service, the environment can be provided in consideration of the fellow passengers such as the infant in the car with the electronic control which will spread in future. Additionally, the setting of the power performance suitable for the aged or handicapped driver can be provided. That is, the present service meets various demands by the electronic circuit control, and can construct and provide the environment where the driver can safely and smoothly drive the car in accordance with the individuality/nature.

It is to be noted that the present invention is not limited only to the above-described embodiment, and can variously be modified and practiced without changing the scope.

According to the present invention, there can be provided a car performance addition service providing system, acquiring system, method, and storage medium in which the setting of a driving environment in a car using an electronic control can appropriately be provided or acquired in accordance with a user's demand.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A car performance addition service providing system in which a predetermined setting division provides an addition service relating to a performance to a car using an electronic control via communication, the system comprising:
first transmission means which transmits setting information relating to the performance to the car;
acceptance means which accepts a request for desired performance setting from the car in accordance with the setting information transmitted by the first transmission means; and
second transmission means which transmits setting data corresponding to the request accepted by the acceptance means to the car.

2. A car performance addition service acquiring system in which a car using an electronic control receives an addition service relating to a performance from a predetermined setting division via communication, the system comprising:
first reception means which receives setting information relating to the performance from the setting division;
request means which requests desired performance setting of the setting division in accordance with the setting information received by the first reception means;
second reception means which receives setting data corresponding to the request of the request means from the setting division; and
change means which changes the setting of a corresponding portion by the setting data received by the second reception means.

3. A car performance addition service providing method of providing an addition service relating to a performance to a car using an electronic control from a predetermined setting division via communication, the method comprising:
a step of receiving communication connection to the setting division from the car;
a step of transmitting setting information relating to the performance to the car;
a step of receiving a request for desired performance setting to the setting division from the car in accordance with the setting information; and
a step of transmitting corresponding setting data to the car in response to the request from the car.

4. The car performance addition service providing method according to claim 3, further comprising:
a step of managing information relating to the car received from a sales division which has sold the car.

5. The car performance addition service providing method according to claim 4, further comprising:
receiving predetermined information relating to the car during the communication connection to the setting division from the car; and
transmitting the setting information relating to the performance to the car, when the received predetermined information agrees with the information relating to the car being managed.

6. The car performance addition service providing method according to claim 3, comprising:
transmitting charge information together with the setting information to the car.

7. The car performance addition service providing method according to claim 3, comprising:
inducing self-diagnosis, after the setting of the corresponding portion is changed in the car.

8. The car performance addition service providing method according to claim 7, comprising:
receiving a result of the self-diagnosis from the car; and analyzing diagnosis data.

9. The car performance addition service providing method according to claim 8, comprising:
receiving position information from the car; searching for a repair division close to the car; and transmitting the diagnosis data and position information to the repair division, when there is a problem in the result of the analysis of the diagnosis data.

10. The car performance addition service providing method according to claim 9, comprising:
urging the repair division to analyze the diagnosis data; and requesting dispatch of a repairer to the car indicated by the position information if necessary.

11. The car performance addition service providing method according to claim 10, comprising:
notifying the car of information relating to repair, after the repair by the repairer ends.

12. The car performance addition service providing method according to claim 3, comprising:
charging a fee via a predetermined financial division, after the changing of the setting by the car ends.

13. The car performance addition service providing method according to claim 10, comprising:
charging a fee via a predetermined financial division, after the repair by the repairer ends.

14. The car performance addition service providing method according to claim 10, comprising:
receiving repair data from the repair division; and changing/managing data relating to the car based on the repair data.

15. The car performance addition service providing method according to claim 3, comprising:
accepting communication from the car, only when a standby signal is received from the car.

16. The car performance addition service providing method according to claim 3, wherein the communication from the car is performed via a cellular phone.

17. The car performance addition service providing method according to claim 5, wherein the predetermined information comprises information peculiar to an owner of the car.

18. A computer readable storage medium in which a car performance addition service providing program is recorded to allow a computer to function as:
first transmission means which transmits setting information relating to a performance to a car using an electronic control;
acceptance means which accepts a request for desired performance setting in accordance with the setting information transmitted by the first transmission means from the car; and
second transmission means which transmits setting data corresponding to the request accepted by the acceptance means to the car.

19. A computer readable storage medium in which a car performance addition service providing program is recorded to allow a computer to function as:
first reception means which receives setting information relating to a performance of a car using an electronic control from a predetermined setting division;
request means which requests desired performance setting of the setting division in accordance with the setting information received by the first reception means;
second reception means which receives setting data corresponding to the request of the request means from the setting division; and
change means which changes the setting of a corresponding portion of the car by the setting data received by the second reception means.
